(19) United States
(12) Patent Application Publication
(10) Pub. No.: US 2023/0280625 A1
(43) Pub. Date: Sep. 7, 2023

(54) LIQUID CRYSTAL DISPLAY DEVICE

(71) Applicant: Japan Display Inc., Tokyo (JP)

(72) Inventor: Koichi IGETA, Tokyo (JP)

(21) Appl. No.: 17/942,587

(22) Filed: Sep. 12, 2022

Related U.S. Application Data
(63) Continuation of application No. PCT/JP2021/002593, filed on Jan. 26, 2021.

(30) Foreign Application Priority Data
Mar. 18, 2020 (JP) 2020-047489

(51) Int. Cl. G02F 1/1368; G02F 1/1362

(52) U.S. Cl. CPC G02F 1/1368; G02F 1/136209; G02F 1/136222

(57) ABSTRACT

The purpose of the present invention is to realize a high contrast ratio in a liquid crystal display device by stacking two liquid crystal display panels without deterioration of screen brightness and weather resistance. The concrete structure is as follows. A liquid crystal display device including; a first liquid crystal display panel, a second liquid crystal display panel and a back light being superposed; in which a negative type liquid crystal is used in one of the first liquid crystal display panel and the second liquid crystal display panel, a TFT and a color filter are formed on the TFT substrate, the counter substrate is nearer to the back light than the TFT substrate is, and a color filter is not formed in a liquid crystal display panel of another one of the first liquid crystal display panel and the second liquid crystal display panel.

The present application is a continuation application of International Application No. PCT/JP2021/002593, filed on Jan. 26, 2021, which claims priority to Japanese Patent Application No. 2020-047489, filed Mar. 18, 2020. The contents of these applications are incorporated herein by reference in their entirety.

### BACKGROUND OF THE INVENTION

### Field of the Invention

The present invention relates to a liquid crystal display device in which a plurality of liquid crystal panels are disposed to raise contrast of images.

### Description of the Related Art

A liquid crystal display device has a structure including a TFT substrate, in which pixels having pixel electrodes and the TFTs (Thin Film Transistor) are arranged in matrix, a counter substrate opposing to the TFT substrate, and a liquid crystal layer sandwiched between the TFT substrate and the counter substrate. A light transmittance of each of the pixels is controlled by liquid crystal molecules in each of the pixels; thus, images are formed. Liquid crystal display devices are now being used in various area since the liquid crystal display devices can be made small and light.

A black display is formed by cutting off the back light, however, it is difficult to cut off completely the back light in the liquid crystal display device. Therefore, the contrast ratio in the liquid crystal display panel is approximately 1000:1. Patent document 1 discloses a technology to raise a contrast of images by stacking two liquid crystal panels.

A liquid crystal display device has a problem in viewing angle. An IPS (In Plane switching) mode liquid crystal display device can mitigate the problem of viewing angle, however, it is not enough. Even in a liquid crystal display panel of IPS mode, there is a problem that a certain color is emphasized according to viewing angle. Patent document 2 discloses to counter measure such a problem of color shift by stacking the liquid crystal display panels of a positive type liquid crystal display panel and a negative type liquid crystal display panel.

### Prior Art Reference

### [Patent Document]

Patent document 1: Japanese patent application laid open No. 2002-131775

Patent document 2: Japanese patent application laid open No. 2018-97155

### SUMMARY OF THE INVENTION

Theoretically, a display device having a contrast ratio of 1,000,000 (M) : 1 can be realized by stacking two liquid crystal display panel, each having a contrast ratio of 1000:1. However, there arises a problem of screen brightness because transmittance of light is decreased by stacking the two liquid crystal display panels.

In the liquid crystal materials, there are positive type liquid crystal (dielectric anisotropy is positive) and negative type liquid crystal (dielectric anisotropy is negative). A transmittance of the liquid crystal display panel using the negative type liquid crystal material (herein after, it is called as a negative type liquid crystal panel) is larger than a transmittance of the liquid crystal display panel using the positive type liquid crystal material (herein after, it is called as a positive type liquid crystal panel).

Consequently, a problem of a decreasing in transmittance can be mitigated by using the negative type liquid crystal lens in a stack manner. The negative type liquid crystal, however, has a problem that a resistance of the liquid crystal decreases when it is irradiated by the back light for a long time, and therefore, a decrease in voltage holding ratio occurs. It is called as weather resistance in this specification. This problem arises concretely as black spots.

The purpose of the present invention is to mitigate a decrease in light transmittance and to improve the weather resistance in a liquid crystal display device in which a plurality of liquid crystal display devices are stacked, and thus to realize a liquid crystal display device having high contras ratio.

The present invention solves the above explained problems; the representative structures are as follows.

A liquid crystal display device including: a first liquid crystal display panel, a second liquid crystal display panel disposed back of the first liquid crystal display pane, and a back light disposed back of the second liquid crystal display panel, in which a negative type liquid crystal is sandwiched between a TFT substrate and a counter substrate in one of the first liquid crystal display panel and the second liquid crystal display panel; a TFT and a color filter are formed on the TFT substrate, the TFT substrate is nearer to the back light than the counter substrate is, and a color filter is not formed in a liquid crystal display panel of another one of the first liquid crystal display panel and the second liquid crystal display panel.

A liquid crystal display device including: a first liquid crystal display panel, a second liquid crystal display panel disposed back of the first liquid crystal display panel, and a back light disposed back of the second liquid crystal display panel; in which a negative type liquid crystal is sandwiched between a TFT substrate and a counter substrate in one of the first liquid crystal display panel and the second liquid crystal display panel, a TFT is formed on the TFT substrate, and a color filter is formed on the counter substrate, the counter substrate is nearer to the back light than the TFT substrate is, and a color filter is not formed in a liquid crystal display panel of another one of the first liquid crystal display panel and the second liquid crystal display panel.

A liquid crystal display device including: a first liquid crystal display panel, a second liquid crystal display panel disposed back of the first liquid crystal display panel, and a back light disposed back of the second liquid crystal display panel; in which a negative type liquid crystal is sandwiched between a TFT substrate and a counter substrate in one of the first liquid crystal display panel and the second liquid crystal display panel, an absorbance of ultraviolet ray of wave length of 340 nm in the negative type liquid crystal, which is diluted 100 times by cyclohexane, is 0.01 or less, a color filter is formed in one of the first liquid crystal display panel and the second liquid crystal display panel, and a color filter is not formed in a liquid crystal display panel of another one of the first liquid crystal display panel and the second liquid crystal display panel.

A liquid crystal display device including: a first liquid crystal display panel, a second liquid crystal display panel disposed back of the first liquid crystal display panel, and a back light disposed back of the second liquid crystal display panel; in which a negative type liquid crystal is sandwiched between a TFT substrate and a counter substrate in one of the first liquid crystal display panel and the second liquid crystal display panel, an absorbance of ultraviolet ray of wave length of 320 nm in the negative type liquid crystal, which is diluted 100 times by cyclohexane, is 0.01 or less, a color filter is formed in one of the first liquid crystal display panel and the second liquid crystal display panel, and a color filter is not formed in a liquid crystal display panel of another one of the first liquid crystal display panel and the second liquid crystal display panel.

### BRIEF DESCRIPTION OF THE DRAWINGS

FIG. 1 is an exploded perspective view of a liquid crystal display device according to the present invention;

FIG. 2 is a graph which shows movements and transmittances of a negative type liquid crystal and a positive type liquid crystal;

FIG. 3 is an accelerated examination of weather resistance;

FIG. 4A is a cross sectional view of a voltage holding ratio test;

FIG. 4B is an equivalent circuit of the voltage holding ratio test;

FIG. 4C is a measuring wave form in the voltage holding ratio test;

FIG. 4D is an example of a wave form at a terminal of a liquid crystal display panel in the voltage holding ratio test;

FIG. 5 is a graph to show a comparison of voltage holding ratios between a positive type liquid crystal and a negative type liquid crystal;

FIG. 6 is a plan view of the liquid crystal display panel;

FIG. 7 is a plan view of a pixel;

FIG. 8 is a cross sectional view of the liquid crystal display panel, which is used in the present invention;

FIG. 9 is a cross sectional view of another structure of the liquid crystal display panel, which is used in the present invention;

FIG. 10 is a cross sectional view of yet another structure of the liquid crystal display panel, which is used in the present invention;

FIG. 11 is a cross sectional view of further yet another structure of the liquid crystal display panel, which is used in the present invention;

FIG. 12 is a cross sectional view of further yet another structure of the liquid crystal display panel, which is used in the present invention;

FIG. 13 is a cross sectional view of first example of first embodiment;

FIG. 14 is a cross sectional view of second example of first embodiment;

FIG. 15 is a cross sectional view of third example of first embodiment;

FIG. 16 is a cross sectional view of fourth example of first embodiment;

FIG. 17 is a cross sectional view of first example of second embodiment;

FIG. 18 is a cross sectional view of second example of second embodiment;

FIG. 19 is a cross sectional view of third example of second embodiment;

FIG. 20 is an example of emitting light spectrum of a back light;

FIG. 21 is a graph which shows an absorbance of a liquid crystal; and

FIG. 22 is a model to examine an absorbance of a liquid crystal.

### DETAILED DESCRIPTION OF THE PREFERRED EMBODIMENTS

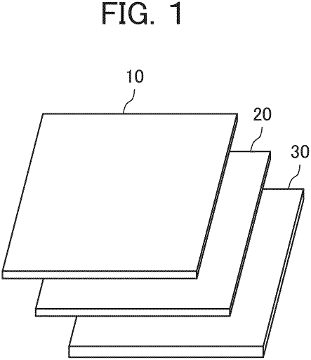

FIG. 1 is an exploded perspective view of a liquid crystal display device according to the present invention. In FIG. 1, a first liquid crystal display panel 10 and a second liquid crystal display panel 20 are stacked one on top of another. The back light 30 is disposed at the back of the second liquid crystal display panel 20. The same liquid crystal display panel can be used for the first liquid crystal display panel 10 and the second liquid crystal display panel 20, however, a color filter can be formed in only one display panel to increase a transmittance of light in total.

The contrast ratio may be increased by using two liquid crystal display devices, however, a transmittance as the liquid crystal display panel decreases; as a result, screen brightness decreases. There are a liquid crystal display panel using a positive type liquid crystal material and a liquid crystal display panel using a negative type liquid crystal material; a transmittance of the negative type liquid crystal display panel is larger than a transmittance of the positive type liquid crystal display panel.

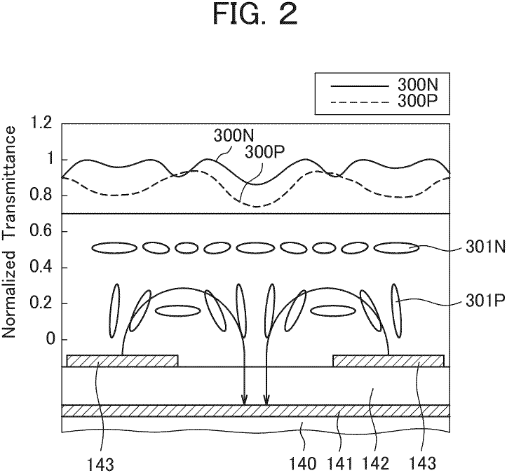

FIG. 2 shows movements of the negative type liquid crystal and the positive type liquid crystal, and light transmittances of the negative type liquid crystal and the positive type liquid crystal. FIG. 2 is movements in a case of an IPS mode liquid crystal display device. In a movement in FIG. 2, a common electrode 141 is formed on an organic passivation film 140; a pixel electrode 143 is formed on a capacitance insulating film 142. A liquid crystal layer exists over the pixel electrode 143. An alignment film is omitted in FIG. 2.

In FIG. 2, when a voltage is applied to the pixel electrode 143, the lines of forces are generated between the common electrode 141 and the pixel electrode 143, then the liquid crystal molecules are rotated. In FIG. 2, 301P is a case of positive type liquid crystal molecules and 301N is a case of negative type liquid crystal molecules. In FIG. 2, the positive type liquid crystal molecules 301P and the negative type liquid crystal molecules 301N are disposed up and down for comparison.

In FIG. 2, the positive type liquid crystal molecules 301P align approximately the lines of forces; however, the negative type liquid crystal molecules 301N rotate in orthogonal direction to the lines of forces. At the top of FIG. 2, the transmittances of the liquid crystal layer are drawn in accordance to the movements of the liquid crystal molecules. In the case of the positive type liquid crystal 300P, minimal transmittance corresponds to the place where the liquid crystal molecules 301P are aligned in vertical direction, and maximal transmittance corresponds to the place where the liquid crystal molecules 301P are aligned in horizontal direction.

On the other hand, in a case of the negative type liquid crystal 300N, a minima exists at places where the negative type liquid crystal molecules 301N do not rotate and at a place where the negative type liquid crystal molecules 301N rotate thoroughly, and there is a maxima between them. As a whole, the negative type liquid crystal 300N has higher transmittance of about 15 % than that of the positive type liquid crystal 300P. Therefore, a decrease in screen brightness by using two liquid crystal panels in stack can be mitigated by using a negative type liquid crystal display panels.

The negative type liquid crystal 300N has poorer weather resistance compared with the positive type liquid crystal 300P. In concrete, the voltage holding ratio decreases due to decreasing in an electric resistance of the liquid crystal layer when the liquid crystal panel is exposed to the back light for a long time; the problem is that a decrease in voltage holding ratio is larger in the negative type liquid crystal display device than that in the positive type liquid crystal display device.

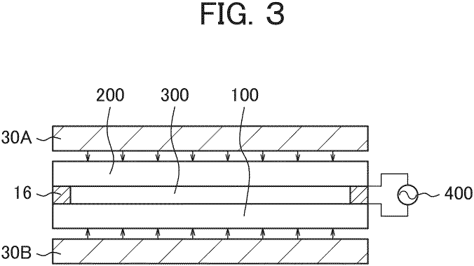

FIG. 3 is a cross sectional view to show a model of accelerating test to examine the weather resistance of the liquid crystal display panel. In FIG. 3, the TFT substrate 100 and the counter substrate 200 adhere to each other by a seal material 16; a liquid crystal layer 300 is sandwiched between them. By the way, since the examination of the weather resistance is an accelerating test, the polarizing plates are not used. The liquid crystal display panel is operated in a normal condition. In the meantime, a vertical electric field is applied to the liquid crystal layer 300 between the TFT substrate 100 and the counter substrate 200.

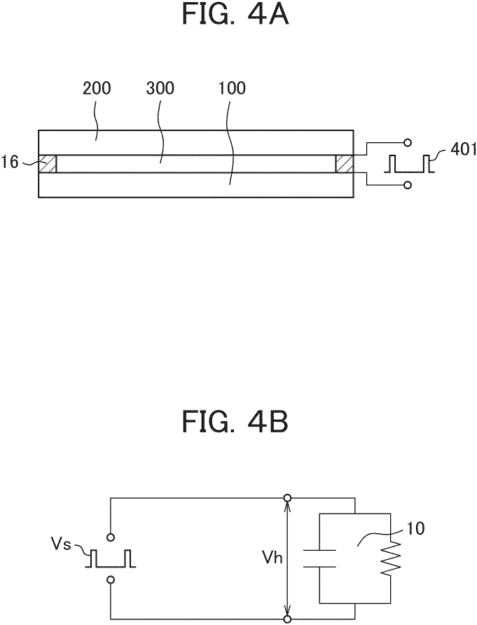

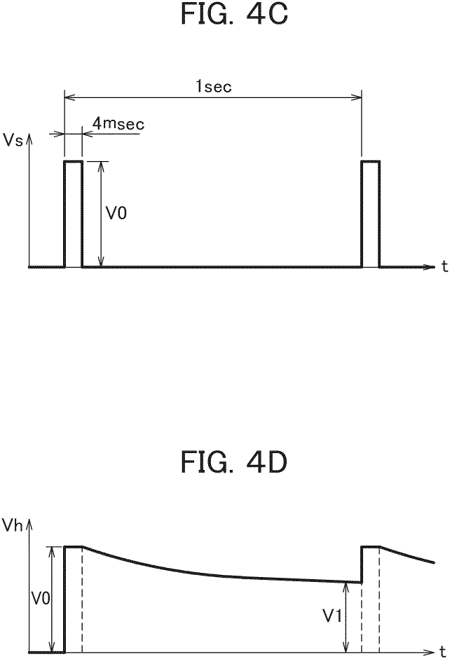

In FIG. 3, the liquid crystal display panel is irradiated with a light intensity of 10000 cd / m² from the top and the bottom with LED back lights 30A and 30B. The voltage holding ratio is examined in every predetermined hour. FIGS. 4A to 4D are figures to explain a definition of a voltage holding ratio and a method for measuring it. FIG. 4A is a cross sectional view of a model to measure the voltage holding ratio. FIG. 4B is an equivalent circuit of FIG. 4A. In FIG. 4B, the liquid crystal display panel 10 is shown by the condenser and the resistance. Vs is a waveform to measure and Vh is a voltage at the terminals of the liquid crystal display panel.

FIG. 4C is a voltage wave Vs for measurement. The measuring voltage is: the crest voltage is V0, the pulse width is 4 millisecond, the period is 1 second. FIG. 4D is a voltage wave Vh, which is measured at the terminals of the liquid crystal display panel, corresponding to the measuring voltage Vs. The terminal voltage Vh does not decrease if there were no deterioration in the liquid crystal layer; on the other hand, if an electrical resistance decreases due to deterioration of the liquid crystal layer, the voltage decreases, e.g., to V1. The value of V1 / V0 is called as the voltage holding ratio. The value of V1 / V0 is better when it is near to 1.

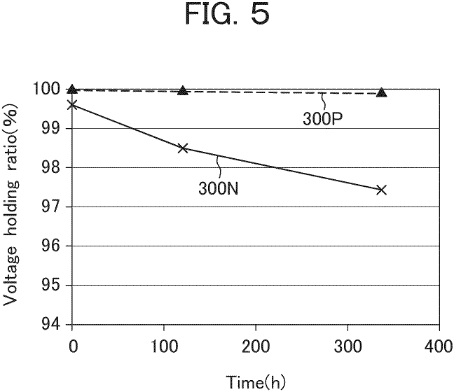

FIG. 5 is a graph comparing the voltage holding ratios of negative type liquid crystal 300N with the positive type liquid crystal 300P when measured with conditions explained in FIGS. 3 and 4A to 4D. The abscissa is time (h) and the ordinate is voltage holding ratio (%) in FIG. 5. As shown in FIG. 5, the voltage holding ratio does not decrease even the time has passed 300 hours in positive type liquid crystal 300P, however, the voltage holding ratio decrease to about 97% in negative type liquid crystal 300N.

As explained by FIG. 2 to FIG. 5, when the negative type liquid crystal is used, the problem of screen brightness is mitigated, however, the problem of weather resistance arises. In the case when two stacked liquid crystal panels are used, an intensity of the back light is strengthened compared with when only one liquid crystal panel is used to compensate a decrease in screen brightness; therefore, a problem of weather resistance is more emphasized. The purpose of the present invention is to realize a structure which can suppress a deterioration in the characteristics in the liquid crystal display panel when the negative type liquid crystal display panels are used in stack to raise a contrast in the liquid crystal display device.

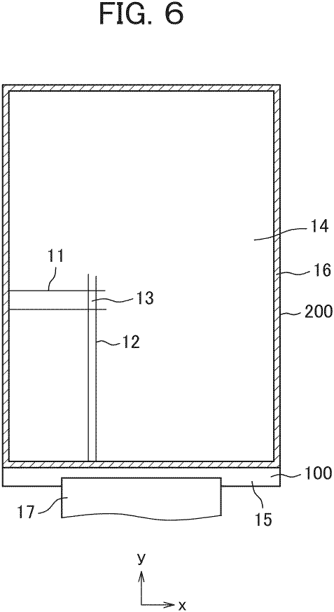

FIG. 6 is a plan view of the liquid crystal display panel. FIG. 6 is common to a first liquid crystal display panel and a second liquid crystal display panel. In FIG. 6, the TFT substrate 100 and the counter substrate 200 adhere to each other by the seal material 16; the liquid crystal layer 300 is sandwiched between them. A display area 14 is formed in an area where the TFT substrate 100 and the counter substrate 200 overlap.

Scanning lines 11 extend in lateral direction (x direction) and are arranged in longitudinal direction (y direction). Video signal lines 12 extend in longitudinal direction (y direction) and are arranged in lateral direction (x direction). A pixel 13 is formed in an area surrounded by the scanning lines 11 and the video signal lines 12. Such a pixel may be called as a sub pixel, however, in this specification, it is called as a pixel.

The TFT substrate 100 is made larger than the counter substrate 200; a terminal area 15 is formed on the TFT substrate 100 where the TFT substrate 100 does not overlap the counter substrate 200. A flexible wiring substrate 17 is connected to the terminal area 15. The driver IC which drives the liquid crystal display device is installed on the flexible wiring substrate 17.

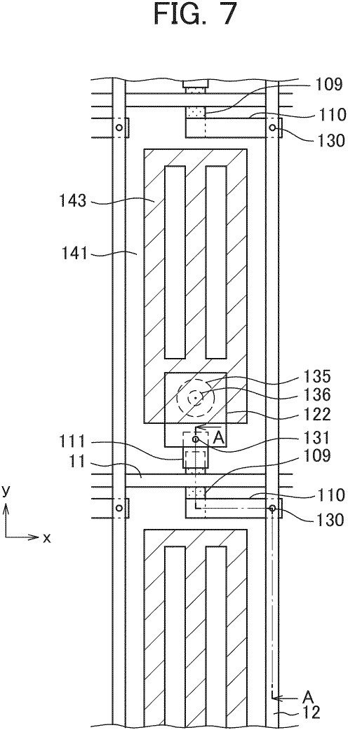

FIG. 7 is a plan view of a pixel in the display area of the liquid crystal display device corresponding to FIG. 6. FIG. 7 is common to the first liquid crystal display panel 10 and the second liquid crystal display panel 20. FIG. 7 is a pixel for the liquid crystal display of a FFS (Fringe Field Switching) mode which belongs to a category of the IPS (In Plane Switching) mode. The scanning lines 11 extend in lateral direction (x direction) and are arranged in longitudinal direction (y direction). The video signal lines 12 extend in longitudinal direction (y direction) and are arranged in lateral direction (x direction). The pixel electrode 143 is formed in an area surrounded by the scanning lines 11 and the video signal lines 12. The oxide semiconductor TFT is formed between the video signal line 12 and the pixel electrode 143. In the meantime, the light shading film is omitted in FIG. 7.

In FIG. 7, a drain electrode 110 is connected with the video signal line 12 via a through hole 130; the drain electrode 110 extends toward an oxide semiconductor 109 of the oxide semiconductor TFT, which is formed for the pixel adjacent to the upper side. One terminal of the oxide semiconductor 109 is connected with the drain electrode 110 by superposing under the drain electrode 110 at under layer than the video signal line 12.

The channel of the TFT is formed at the place where the oxide semiconductor film 109 goes under the scanning line 11. In FIG. 7, the scanning line 11 works as a gate electrode 114. The oxide semiconductor film 109 is given conductivity by e.g. doping Boron (B) through an ion implantation except the area directly under the gate electrode 114, namely, under the scanning line 11. In the meantime, in addition to Boron (B), Phosphorus (P) or Argon (Ar) can be used as doping ion in the ion implantation. The region of the oxide semiconductor film 109 in which ions are doped by the ion implantation is n+ region.

Another terminal of the oxide semiconductor film 109 is superposed and connected to the source electrode 111. The source electrode 111 extends to the pixel electrode 143, and is connected to a contact electrode 122 via a through hole 131. The contact electrode 122 is connected with the pixel electrode 143 via a through hole 135 formed in the organic passivation film 140 and a through hole 136 formed in the capacitance insulating film. The pixel electrode 143 is formed as comb shaped.

The common electrode 141 is formed under the pixel electrode 143 in a plane shape. When a voltage is applied to the pixel electrode 143, the lines of forces are generated between the common electrode 141 and the pixel electrode 143 to rotate the liquid crystal molecules, thus, controls a transmittance of the liquid crystal layer in the pixel.

Examples of the oxide semiconductor include IGZO (Indium Gallium Zinc Oxide), ITZO (Indium Tin Zinc Oxide), ZnON (Zinc Oxide Nitride), and IGO (Indium Gallium Oxide). By the way, TFT is not necessarily limited to the semiconductor TFT, but other TFTs as e.g. the polysilicon TFT can be used.

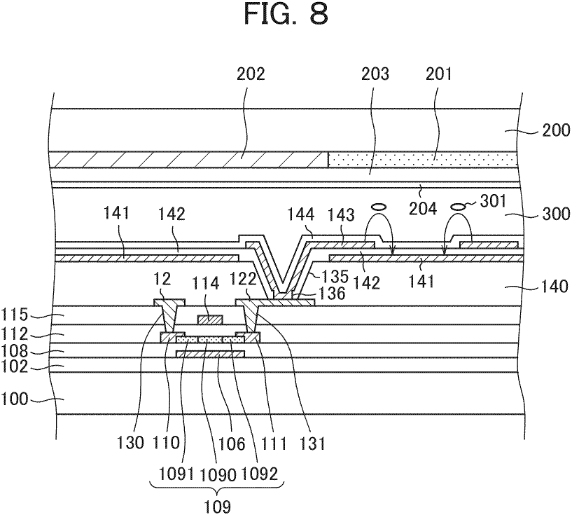

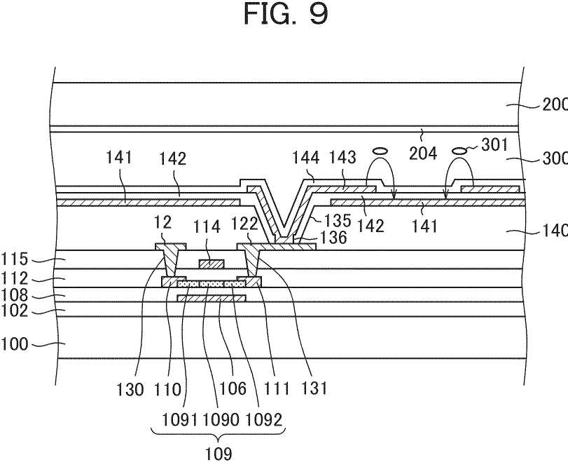

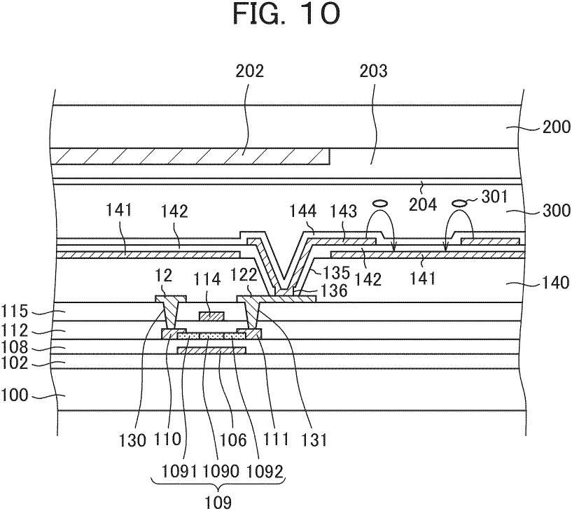

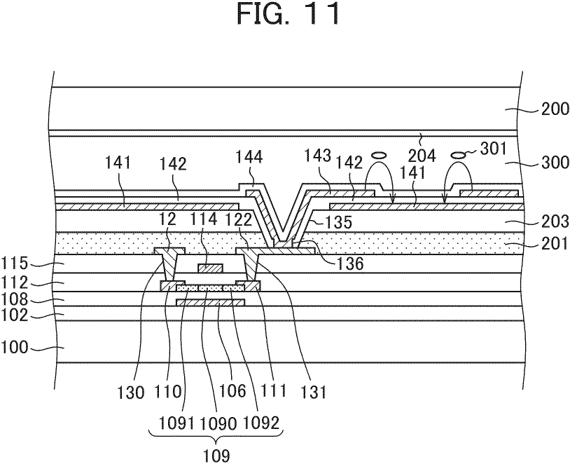

FIG. 8, which corresponds to A-A cross section in FIG. 7, is a cross sectional view of general structure of the IPS mode liquid crystal display device. FIG. 9 to FIG. 12 are cross sectional views of the first liquid crystal display panel and the second liquid crystal display panel used in the present invention in addition to the structure of FIG. 8. The structures and functions of various combinations of the liquid crystal display panels of FIGS. 8 to 12 are explained in the embodiment which is described later.

At the outset, the structure of FIG. 8, which is general structure, is explained. In FIG. 8, an under coat film 102 is formed covering the TFT substrate 100. The under coat film 102 prevents the oxide semiconductor film 109 from being contaminated by impurities from the TFT substrate which is formed from glass or resin of polyimide. The under coat film 102 is formed from a laminated film of a silicon oxide film (SiO) and a silicon nitride film (SiN) in many cases.

A light shading film 106 is formed from metal on the under coat film 102. This metal can be the same metal as the gate electrode and so forth. The light shading film 106 is to stop the light from the back light so that the channel region of the TFT, which is formed later, is not irradiated with the light from the back light. The light shading film 106 can work as a shield electrode to suppress an influence on the TFT when the substrate 100 is charged. In addition, the light shading film 106 can be used as a bottom gate electrode by applying a gate voltage.

A buffer insulating film 108 is formed covering the light shading film 106. The buffer insulating film 108 is formed from silicon insulating film. The roles of the buffer insulating film 108 is to supply oxygen to the oxide semiconductor film 109 formed on it, and to prevent the light shading film 106, which is made of metal, from absorbing oxygen from the oxide semiconductor film 109. By the way, if the light shading film 106 is used as a bottom gate, it works as a bottom gate insulating film.

In FIG. 8, the oxide semiconductor film 109, which constitutes the TFT, is formed on the buffer insulating film 108. The oxide semiconductor film 109 can be formed by sputtering. A thickness of the oxide semiconductor film 109 is 10 to 100 nm. In the present invention, the oxide semiconductor film 109 is formed from IGZO film in a thickness of 50 nm.

The oxide semiconductor film 109 is constituted from a channel region 1090, a drain region 1091 and a source region 1092. A conductivity is given to the drain region 1091 and the source region 1092 by ion implantation using the gate electrode 114 as a mask. The channel region 1090 is formed directly under the gate electrode 114.

The drain electrode 110 is superposed on one terminal of the oxide semiconductor film 109 and the source electrode 111 is superposed on another terminal of the oxide semiconductor film 109. The drain electrode 110 and the source electrode 111 can be formed from the same material as the gate electrode 114 or formed from Titanium (Ti) film. In the oxide semiconductor film 109, the regions on which the source electrode 111 or the drain electrode 110 is superposed are conductive because oxygen in the oxide semiconductor film 109 is absorbed by the metal.

The gate insulating film 112 is formed from SiO covering the oxide semiconductor film 109, the drain electrode 110 and the source electrode 111. The gate insulating film 112 is made as an oxide rich film to stabilize the characteristics of the oxide semiconductor TFT by supplying oxygen to the channel region 1090 of the oxide semiconductor film 109.

The gate electrode 114 is formed on the gate insulating film 112. The gate electrode 114 is formed from e.g. a laminated film of Ti — Al — Ti (Titanium - Aluminum - Titanium) or an alloy of MoW. As shown in FIG. 7, the scanning line 11 works as a gate insulating film 114.

Even it is omitted in FIG. 8, an aluminum oxide film is sometimes formed between the gate electrode 114 and the gate insulating film 112. The purpose is to supply more oxygen to the channel region 1090 of the oxide semiconductor film 109 to make more stabilize the characteristics of the TFT. A thickness of the aluminum oxide film can be approximately 10 nm in this case.

An interlayer insulating film 115 is formed covering the gate electrode 114. The interlayer insulating film 115 is formed from a laminated film of a silicon oxide film and a silicon nitride film in many cases. It is determined by design purpose which film is set at top or bottom.

In FIG. 8, in the interlayer insulating film 115 and the gate insulating film 112, the through hole 130 is formed to connect the video signal line 12 and the drain electrode 110 with each other, and the through hole 131 is formed to connect the contact electrode 122 and the source electrode 111 with each other. The contact electrode 122 extends on the interlayer insulating film 115 and is connected with the pixel electrode 143 via the through holes 135 and 136.

In FIG. 8, an organic passivation film 140 is formed covering the interlayer insulating film 115. The organic passivation film 140 is formed from e.g. acrylic resin. The organic passivation film 140 is formed thick as in a thickness of 2 to 4 µm to work as a flattening film and also to decrease a floating capacitance between the video signal line 12 and the common electrode 141. The through hole 135 is formed in the organic passivation film 140 to connect the contact electrode 122 and the pixel electrode 143 with each other.

The common electrode 141 is formed from a transparent conductive film as ITO (Indium Tin Oxide) on the organic passivation film 140. The common electrode 141 is formed in plane. The capacitance insulating film 142 is formed from silicon nitride film covering the common electrode 141. The pixel electrode 143 is formed from a transparent conductive film as ITO on the capacitance insulating film 142. The pixel electrode 143 is formed as comb shaped. The capacitance insulating film 142 is called as above because it forms a pixel capacitance between the common electrode 141 and the pixel electrode 143.

An alignment film 144 is formed covering the pixel electrode 143. The alignment film 144 determines an intimal aliment direction of liquid crystal molecules 301. Either a rubbing method or a photo alignment method using a polarized ultraviolet ray is used in alignment process. The photo alignment method is advantageous in the IPS mode because the IPS mode does not need a pre-tilt angle.

In FIG. 8, the counter substrate 200 is disposed over the TFT substrate 100 sandwiching the liquid crystal layer 300 therebetween. A color filter 201 and a black matrix 202 are formed on the counter substrate 200 and a over coat film 203 is formed covering the color filter 201 and the black matrix 202. An alignment film 204 is formed on the over coat film 203. A function and a manufacturing method of the alignment film 204 are the same as explained for the alignment film 144 formed on the TFT substrate 100.

In FIG. 8, when a voltage is applied between the common electrode 141 and the pixel electrode 143, lines of forces as shown by arrows in FIG. 8 are generated to rotate the liquid crystal molecules 301, and thus, a transmittance of the light from the backlight in the liquid crystal layer 300 can be controlled. Images are formed by controlling the transmittance of the light in every pixel.

FIG. 9 is an example of the liquid crystal display panel used in the present invention. The liquid crystal display panel of the structure of FIG. 9, which is used for either the first liquid crystal display panel 10 or the second liquid crystal display panel 20, is used for improving the contrast ratio but not for forming images. FIG. 9 differs from FIG. 8 in that the color filter, the black matrix and the over coat film are not formed on the counter substrate 200.

Therefore, the structure of FIG. 9 can form images, however, it cannot form color images. The color images are formed in the other liquid crystal display panel. Since the structure of FIG. 9 dose not use color filter, a transmittance of the light can be raised, thus, decrease in screen brightness can be mitigated.

FIG. 10 is another example of the liquid crystal display panel used in the present invention. The liquid crystal display panel of the structure of FIG. 10, which is used for either the first liquid crystal display panel 10 or the second liquid crystal display panel 20, is used for improving the contrast ratio but not for forming images. FIG. 10 differs from FIG. 8 in that the color filter is not formed on the counter substrate 200. FIG. 10 differs from FIG. 9 in that the black matrix 202 and the over coat 203 exist in FIG. 10.

When the structure of FIG. 9 is used as the first liquid crystal display panel 10, under the influence of outside light, photo current is generated or display qualification is deteriorated by reflection from the video signal lines 12 and the scanning lines 11. The structure of FIG. 10 can suppress the influence of outside light or the reflections of outside light by the black matrix 202, thus it is advantageous when it is used as the first liquid crystal display panel 10.

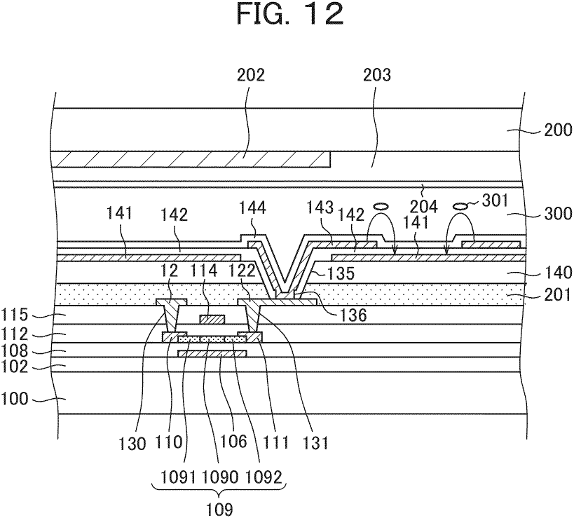

FIG. 11 is yet another example of the liquid crystal display panel used in the present invention. The color filter 201 is formed on the TFT substrate 100, not on the counter substrate 200, in the liquid crystal display panel of the structure of FIG. 11. In FIG. 11, the color filter 201 is formed covering the interlayer insulating film 115, the drain electrode 12, the source electrode 122 and so forth; the over coat film 203 is formed on the color filter 201. Either one of red, green, and blue color filter is formed in the pixel. A thickness of the color filter is approximately 2 µm and a thickness of the over coat film 203 is approximately 2 µm. The over coat film 203 has also a role of a flattening film.

In FIG. 11, only the alignment film 204 is formed on the counter substrate 200. In the structure of FIG. 11, an intensity of the light from the back light 30 is decreased to ⅓ theoretically, when it enters the liquid crystal layer 300. Therefore, the weather resistance can be improved even when the negative type liquid crystal 300N is used. In other words, a decrease in a voltage holding ratio can be mitigated even when the negative type liquid crystal 300N is used. The structure of FIG. 11 can be used for either the first liquid crystal display panel 10 or the second liquid crystal display panel 20.

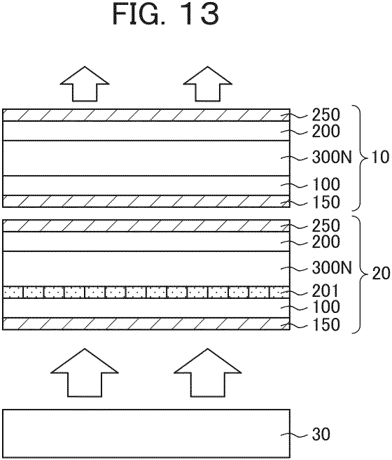

FIG. 12 is further yet another example of the liquid crystal display panel used in the present invention. The color filter 201 is formed on the TFT substrate 100, not on the counter substrate 200, in the liquid crystal display panel of the structure of FIG. 12. FIG. 12 differs from FIG. 11 in that the black matrix 202 and the over coat film 203 are formed on the counter substrate 200. In FIG. 12, the organic passivation film 140 is formed on the color filter 201 formed on the TFT substrate 100, however, this film can be the same as the over coat film 203 in FIG. 11.

When the structure of FIG. 11 is used as the first liquid crystal display panel 10, under the influence of outside light, photo current is generated or display qualification is deteriorated by reflection from the video signal lines 12 and the scanning lines 11. The structure of FIG. 12 can suppress the influence of outside light or the reflections of outside light by the black matrix 202, thus it is advantageous when it is used as a first liquid crystal display panel 10. Other structures in FIG. 12 are the same as explained in FIG. 11.

Either the negative type liquid crystal or the positive type liquid crystal can be used as the liquid crystal layer 300 in the liquid crystal display panel of FIGS. 8 to 12. The present invention can realize the liquid crystal display device of high contrast ratio, and can suppress a decrease in screen brightness and counter measure weather resistance when the negative type liquid crystal is used in the liquid crystal display panels of FIGS. 8 to 12, or when either the negative type liquid crystal or the positive type liquid crystal is used in one of the first liquid crystal display panel 10 and the second liquid crystal display panel 20.

### Embodiment 1

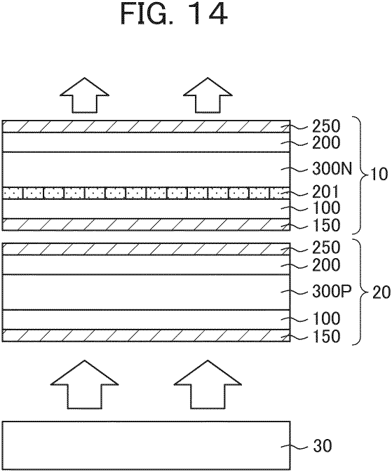

FIG. 13 is a cross sectional view of first example of embodiment 1. The feature of example 1 is that the negative type liquid crystal 300N is used in both the first liquid crystal display panel 10 and the second liquid crystal display panel 20. Therefore, a screen brightness can be increased to 1.15 × 1.15 = 1.3225 times.

In FIG. 13, the color filter 201 is formed on the TFT substrate 100 in the second liquid crystal display panel 20, which is nearer to the back light 30, that is to say, the structure of FIG. 11 is used. On the other hand, the first liquid crystal display panel 10 uses the structure of FIG. 9. The first liquid crystal display panel 10 does not form color images, however, it works as a panel for improving contrast ratio. In the meantime, if there occurs a problem of reflection of outside light or so forth, the structure of FIG. 10 can be used as the first liquid crystal display panel 10.

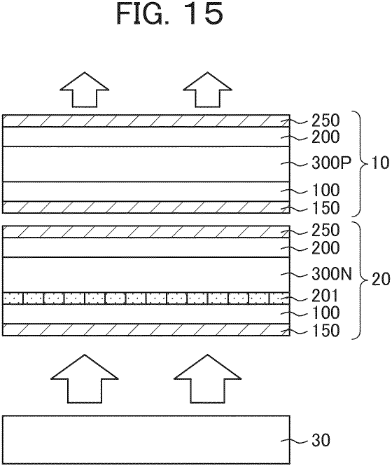

FIG. 14 is a cross sectional view of second example of embodiment 1. The feature of FIG. 14 is that negative type liquid crystal 300N is used in the first liquid crystal display panel 10 and positive type liquid crystal 300P is used in the second liquid crystal display panel 20. The color filter 201 is not formed in the second liquid crystal display panel 20, which is nearer to the back light 30, that is to say, the structure of FIG. 9 is used. Negative type liquid crystal 300N is used in the first liquid crystal display panel 10, however, the color filter 201 is formed on the TFT substrate 100, that is to say, the structure of FIG. 11 is used.

Since the intensity of the light, which enters the negative type liquid crystal 300N, has passed the second liquid crystal display panel 20 and the color filter 201 formed on the TFT substrate 100 of the first liquid crystal display panel 10, is further decreased than in a case of first example, thus, the problem of weather resistance of negative type liquid crystal 300N is further mitigated. The screen brightness is improved approximately 15% compared with when positive type liquid crystal is used in both the first liquid crystal display panel 10 and the second liquid crystal display panel 20. In the meantime, if there occurs a problem of reflection of outside light or so forth, the structure of FIG. 12 can be used as the first liquid crystal display panel 10.

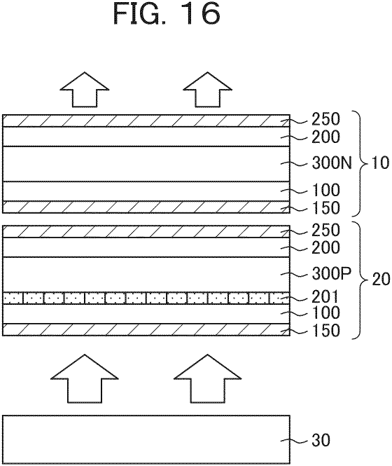

FIG. 15 is a cross sectional view of third example of embodiment 1. The feature of FIG. 15 is that negative type liquid crystal 300N is used in the second liquid crystal display panel 20, which is nearer to the back light 30, and positive type liquid crystal 300P is used in the first liquid crystal display panel 10. Although negative type liquid crystal 300N is used in the second liquid crystal display panel 20, which is nearer to the back light 30, the color filter 201 is formed on the TFT substrate 100, thus, problem of weather resistance can be mitigated.

The color filter 201 is not formed in the first liquid crystal display panel 10 in which negative type liquid crystal 300N is used, that is to say, it is a structure of FIG. 9. The first liquid crystal display panel 10 is used to improve contrast ratio. In the meantime, if there occurs a problem of reflection of outside light or so forth, the structure of FIG. 10 can be used as the first liquid crystal display panel 10.

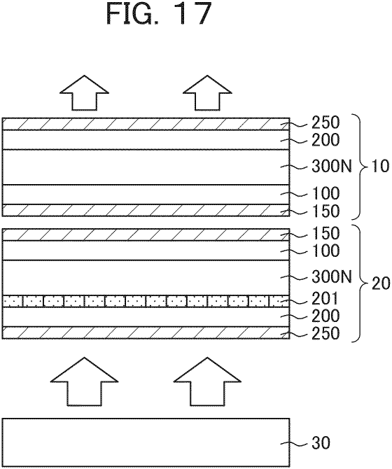

FIG. 16 is a cross sectional view of fourth example of embodiment 1. The feature of FIG. 16 is that positive type liquid crystal 300P is used in the second liquid crystal display panel 20, which is nearer to the back light 30, and negative type liquid crystal 300N is used in the first liquid crystal display panel 10. Even positive type liquid crystal 300P is used in the second liquid crystal display panel 20, which is nearer to the back light 30, the color filter 201 is formed on the TFT substrate 100.

The color filter 201 is not formed in the first liquid crystal display panel 10 in which negative type liquid crystal 300N is used, namely, the structure of FIG. 9 is used. Since the back light, which enters the negative type liquid crystal 300N, has passed the color filter 201 formed on the TFT substrate 100 of the first liquid crystal display panel 10, intensity of the light is decreased; thus, a problem of weather resistance is mitigated. In the meantime, if there occurs a problem of reflection of outside light or so forth, the structure of FIG. 10 can be used as the first liquid crystal display panel 10.

### Embodiment 2

In embodiment 1, it is characterized in that the color filter 201 is formed on the TFT substrate 100 when color images are formed in the liquid crystal display panel using negative type liquid crystal 300N. However, there is a case in which it is difficult to form the color filter 201 on the TFT substrate 100. Embodiment 2 presents a structure that the light from the back light enters the negative type liquid crystal 300N after it has passed the color filter 201 even the color filter 201 is formed on the counter substrate 200.

FIG. 17 is a cross sectional view of first example of embodiment 2. In FIG. 17, both the first liquid crystal display panel 10 and the second liquid crystal display panel 20 use negative type liquid crystal 300N; however, the second liquid crystal display panel 20, which is nearer to the back light 30, is used as upside down. That is to say, since the counter substrate 200, on which the color filter 201 is formed, is nearer to the back light 30, the intensity of the light which enters the negative type liquid crystal 300N is already decreased, therefore, a problem of weather resistance can be mitigated.

The first liquid crystal display panel 10 in FIG. 17 uses negative type liquid crystal 300N; the structure is the same as the structure of FIG. 9. In the meantime, if there occurs a problem of reflection of outside light or so forth, the structure of FIG. 10 can be used as the first liquid crystal display panel 10. A problem of reflection of outside light from the wirings and so forth, due to using the second liquid crystal display panel 20 upside down, can be mitigated by adopting the structure of FIG. 10.

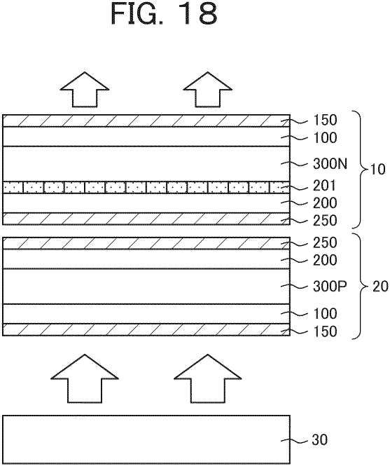

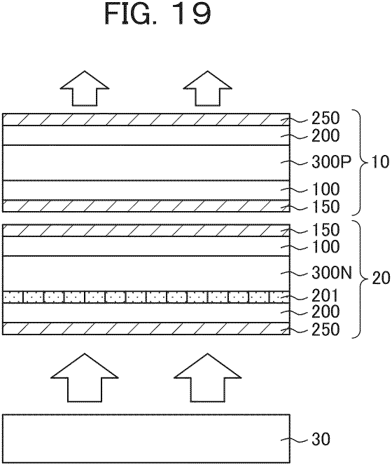

FIG. 18 is a cross sectional view of second example of embodiment 2. In FIG. 18, negative type liquid crystal 300N is used in the first liquid crystal display panel 10; positive type liquid crystal 300P is used in the second liquid crystal display panel 20. The first liquid crystal display panel 10 is used in upside down. That is to say, the structure of the first liquid crystal display panel 10 is the same as FIG. 8, however, the structure of FIG. 8 is set upside down.

Since the intensity of the light, which enters the negative type liquid crystal 300N, has passed the second liquid crystal display panel 20 and the color filter 201 formed on the counter substrate 200 of the first liquid crystal display panel 10, is decreased; thus, the problem of weather resistance of negative type liquid crystal 300N is mitigated. In the meantime, the structure of FIG. 9 can be used for the second liquid crystal display panel 20, which is nearer to the back light 30.

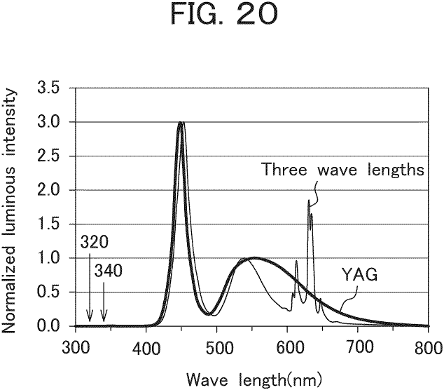

FIG. 19 is a cross sectional view of third example of embodiment 2. In FIG. 19, positive type liquid crystal 300P is used in the first liquid crystal display panel 10; negative type liquid crystal 300N is used in the second liquid crystal display panel 20. The second liquid crystal display panel 20 is used in upside down. That is to say, the structure of the second liquid crystal display panel 20 is the same as FIG. 8, however, the structure of FIG. 8 is disposed upside down.

The structure and function of the first liquid crystal display panel 10 in FIG. 19 is the same as the first example of FIG. 17. FIG. 19 differs from FIG. 17 in that the first liquid crystal display panel 10 uses positive type liquid crystal 300P. The structure of the first liquid crystal display panel 10 can be the same structure as FIG. 9; however, when problems of reflection of outside light or the like occur, the structure of FIG. 10 can be used.

### Embodiment 3

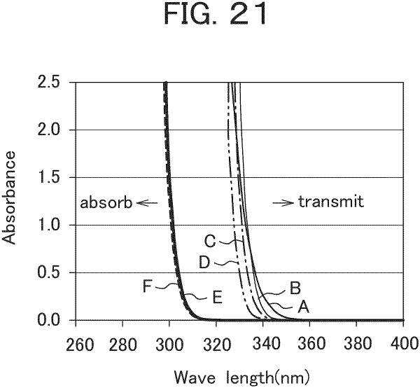

The white LED (Light Emitting Diode) is used for the back light. The white LED is formed from three LEDs, each of which emits light of red, green or blue; or the white LED is formed from a blue LED combined with fluorescent material of YAG:Ce, which emits yellow light. FIG. 20 is a graph of two cases in which the light emitting spectrum when three LEDs are used, noted with “THREE WAVE LENGTH,” and the light emitting spectrum when a blue LED combined with fluorescent material of YAG:Ce, noted with “YAG” is used.

In FIG. 20, the abscissa is wave length and the ordinate is normalized intensity of emitting light. As shown in FIG. 20, the spectrum of the emitting light of the back light used for the liquid crystal display device is designed so as to exist in the visible light region. On the other hand, the light of the wave length of 340 nm or the light of the wave length of 320 nm exist, even they are not much, in normalized light intensity corresponding to ordinate of FIG. 20. However, it has become understood such a high energy ultraviolet ray, even the intensity is small, influences on the characteristics of weather resistance when it is absorbed by the liquid crystal layer.

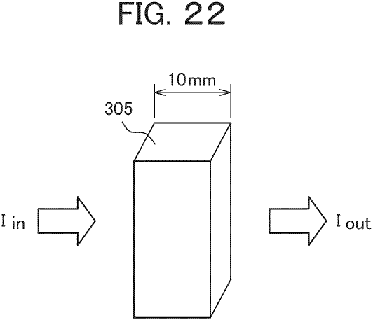

The liquid crystal has characteristics to transmit visible light and to absorb ultraviolet ray. Therefore, when ultraviolet ray is emitted from the back light, even the amount is small, it is absorbed in the liquid crystal layer 300; thus, raises a problem of weather resistance of the liquid crystal. FIG. 21 is a graph to show absorption spectrum for six liquid crystal materials. In FIG. 21, the abscissa is wave length and the ordinate is absorbance. The spectrophotometer U-3310 of Hitachi Ltd. is used as the measuring machine.

In FIG. 21, the absorption edge shifts to short wave length side in an order of liquid crystal materials A to F. That is to say, absorption of the ultraviolet ray becomes smaller according to the absorption edge shifts to the short wave length side; therefore, the problem of weather resistance is mitigated. In the weather resistance test, the voltage holding ratio is decreased and thus, black spots are observed when the materials A, B and C in FIG. 21 are used. On the other hand, in the weather resistance test, the voltage holding ratio is kept and thus, black spots are not observed when the materials D, E and F in FIG. 21 are used.

FIG. 22 is a model to measure absorbance of the liquid crystal materials. In FIG. 22, the liquid crystal material for measurement is diluted 100 times by cyclohexane and is adopted in the quartz container so that a thickness of a diluted liquid crystal material 305 is 10 mm. The absorption by the quartz is almost zero in a range of the measuring wave length. In FIG. 22, the light Iin enters the liquid crystal material 305 from the left hand side, and the light Iout, which is emitted from the liquid crystal material 305, is measured. The absorbance of the liquid crystal layer is defined as -log₁₀ (Iout/Iin) .

The liquid crystal materials A, B, C, D, E and F in FIG. 21 are diluted 100 times by cyclohexane, and measured. Examining precisely the result of FIG. 21, at a wave length of 340 nm, the absorbance by the materials A, B, and C are 0.01 or more, but the absorbance by the materials D, E, and F are 0.01 or less. That is to say, at a wave length of 340 nm, if absorbance by the liquid crystal is 0.01 or less, the problem of the weather resistance can be neglected. Further, if absorbance is 0.005 or less, the weather resistance characteristic of the liquid crystal display device is further improved.

The absorption edge of the liquid crystal materials E and F shift much to short wave length side compared with other materials. Concretely, at a wave length of 320 nm, the absorption edge is 0.01 or less. Therefore, using the materials E or F, even they are negative type liquid crystals, the liquid crystal display device can have a good weather resistance characteristic. Further, if absorbance is 0.005 or less, at the wave length of 320 nm, the weather resistance characteristic of the liquid crystal display device is further improved.

What is claimed is:

1. A liquid crystal display device comprising:
a first liquid crystal display panel,
a second liquid crystal display panel disposed back of the first liquid crystal display panel, and
a back light disposed back of the second liquid crystal display panel,
wherein a negative type liquid crystal is sandwiched between a TFT substrate and a counter substrate in one of the first liquid crystal display panel and the second liquid crystal display panel,
a TFT and a color filter are formed on the TFT substrate,
the TFT substrate is nearer to the back light than the counter substrate is, and
a color filter is not formed in a liquid crystal display panel of another one of the first liquid crystal display panel and the second liquid crystal display panel.

2. The liquid crystal display device according to claim 1,
wherein a negative type liquid crystal is used in the another one of the first liquid crystal display panel and the second liquid crystal display panel.

3. The liquid crystal display device according to claim 1,
wherein a positive type liquid crystal is used in the another one of the first liquid crystal display panel and the second liquid crystal display panel.

4. The liquid crystal display device according to claim 1,
wherein the one of the first liquid crystal display panel and the second liquid crystal display panel is the first liquid crystal display panel.

5. The liquid crystal display device according to claim 1,
wherein one of the first liquid crystal display panel and the second liquid crystal display panel is the second liquid crystal display panel.

6. The liquid crystal display device according to claim 1,
wherein a black matrix is formed in the another one of the first liquid crystal display panel and the second liquid crystal display panel.

7. A liquid crystal display device comprising:
a first liquid crystal display panel,
a second liquid crystal display panel disposed back of the first liquid crystal display panel, and
a back light disposed back of the second liquid crystal display panel,
wherein a negative type liquid crystal is sandwiched between a TFT substrate and a counter substrate in one of the first liquid crystal display panel and the second liquid crystal display panel,
a TFT is formed on the TFT substrate, and a color filter is formed on the counter substrate,
the counter substrate is nearer to the back light than the TFT substrate is, and
a color filter is not formed in a liquid crystal display panel of another one of the first liquid crystal display panel and the second liquid crystal display panel.

8. The liquid crystal display device according to claim 7,
wherein a negative type liquid crystal is used in the another one of the first liquid crystal display panel and the second liquid crystal display panel.

9. The liquid crystal display device according to claim 7,
wherein a positive type liquid crystal is used in the another one of the first liquid crystal display panel and the second liquid crystal display panel.

10. The liquid crystal display device according to claim 7,
the one of the first liquid crystal display panel and the second liquid crystal display panel is the first liquid crystal display panel.

11. The liquid crystal display device according to claim 7,
wherein the one of the first liquid crystal display panel and the second liquid crystal display panel is the second liquid crystal display panel.

12. The liquid crystal display device according to claim 7,
wherein a black matrix is formed in the another one of the first liquid crystal display panel and the second liquid crystal display panel.

13. A liquid crystal display device comprising:
a first liquid crystal display panel,
a second liquid crystal display panel disposed back of the first liquid crystal display panel, and
a back light disposed back of the second liquid crystal display panel,
wherein a negative type liquid crystal is sandwiched between a TFT substrate and a counter substrate in one of the first liquid crystal display panel and the second liquid crystal display panel,
an absorbance of ultraviolet ray of wave length of 340 nm in the negative type liquid crystal, which is diluted 100 times by cyclohexane, is 0.01 or less,
a color filter is formed in one of the first liquid crystal display panel and the second liquid crystal display panel, and
a color filter is not formed in a liquid crystal display panel of another one of the first liquid crystal display panel and the second liquid crystal display panel.

14. The liquid crystal display device according to claim 13,
wherein the absorbance of ultraviolet ray of wave length of 340 nm in the negative type liquid crystal, which is diluted 100 times by cyclohexane, is 0.005 or less.

15. The liquid crystal display device according to claim 13,
wherein the negative type liquid crystal is used in both the first liquid crystal display panel and the second liquid crystal display panel.

16. A liquid crystal display device comprising:
a first liquid crystal display panel,
a second liquid crystal display panel disposed back of the first liquid crystal display panel, and
a back light disposed back of the second liquid crystal display panel,
wherein a negative type liquid crystal is sandwiched between a TFT substrate and a counter substrate in one of the first liquid crystal display panel and the second liquid crystal display panel,
an absorbance of ultraviolet ray of wave length of 320 nm in the negative type liquid crystal, which is diluted 100 times by cyclohexane, is 0.01 or less,
a color filter is formed in one of the first liquid crystal display panel and the second liquid crystal display panel, and
a color filter is not formed in a liquid crystal display panel of another one of the first liquid crystal display panel and the second liquid crystal display panel.

17. The liquid crystal display device according to claim 16,
wherein the absorbance of ultraviolet ray of wave length of 320 nm in the negative type liquid crystal, which is diluted 100 times by cyclohexane, is 0.005 or less.

18. The liquid crystal display device according to claim 16,
wherein the negative type liquid crystal is used in both the first liquid crystal display panel and the second liquid crystal display panel.
